(19) United States
(12) Patent Application Publication
(10) Pub. No.: US 2015/0380178 A1
(43) Pub. Date: Dec. 31, 2015

(54) AUTOMOBILE PUSH-BUTTON TYPE CONTROL DEVICE

(71) Applicant: E-LEAD ELECTRONIC CO., LTD., Changhua (TW)

(72) Inventor: Stephen CHEN, CHANGHUA (TW)

(21) Appl. No.: 14/318,659

(22) Filed: Jun. 29, 2014

(51) Int. Cl. H01H 9/02; H01H 13/50

(52) U.S. Cl. CPC H01H 9/0271; H01H 13/50; H01H 2231/026

(57) ABSTRACT

An automobile push-button type control device is disclosed. The device comprises a casing, a circuit module, a button set and a USB plug, wherein the circuit module is connected to an electronic device, thereby the vehicle with the device can connect to various related automobile electronic products without changing the original design of the vehicle. Thus, the device can provide a more convenient and easy-to-operate interface for users to expand the functions of the vehicles than before.

### BACKGROUND OF THE INVENTION

(a) Field of the Invention

The present invention generally relates to an automobile push-button type control device, in particular to an automobile push-button type control device capable of providing an interface for users to connect various related automobile electronic products to their vehicle without changing the original design of the vehicles. Thus, the device can provide a more convenient and easy-to-operate interface than before for users to expand the functions of the vehicles.

(b) Description of the Prior Art

With the rapid advance of the automobile industry, various automobile electronic accessories are developed. Thus, the number of control buttons is also more than before, the space of the dashboard is not enough to use. Further, the original design of the dashboard cannot space any space for additional blind plugs for installation of other switches. However, in response to the competitiveness of the sales market or the preferences of car owners, various accessories may be installed on the vehicle, however, these accessories will need a lot of space to install their control buttons, which will be a serious problem. Previously, additional switches may be installed on a car by sticking, drilling hole or screws, which may destroy the original appearance of the car or damage the body of the car and cause complaints from the car owner.

For the purpose of solving the problem of the installation of additional automobile accessories, various devices for integrating and connecting these accessories are developed to expand the functions and improve the above problems, such as wirelessly transmitting multi-media data or the control switch, charging device, connector and electric taking out socket connected to the power supply of the car. These devices and their related embodiments are disclosed by TW 1222789, TW M254380, TW M285485, TW M327816, TW M415502, TW M425800 and TW M342674, etc.

The above devices can actually solve some problems about the installation of additional automobile electronic accessories; but, as the number of the automobile electronic accessories to be installed is much more than before, these devices can no longer completely solve installation and operation of these accessories, which will be a serious problem for users.

### SUMMARY OF THE INVENTION

In order to overcome the shortcomings of the prior art, the inventor keeps on carving unflaggingly through wholehearted experience and research to develop the present invention, which can effectively improve the defects described above. In other words, it is a primary objective of the present invention to provide an automobile push-button type control device capable of facilitating the installation and connection of automobile electronic accessories without destroy the original of cars, and providing a more convenient and easy-to-operate interface for car owners to expand the functions of the cars.

To achieve the foregoing objective, the first embodiment of the present invention provides an automobile push-button type control device. The device may comprise a casing, a circuit module, a button set and a USB plug. The casing may have an accommodating space. The circuit module may be disposed in the accommodating space. The button set may be disposed above the circuit module and electrically connected to the circuit module. The USB plug may be disposed below the circuit module and electrically connected to the circuit module.

In a preferred embodiment of the present invention, the automobile push-button type control device may further comprise an automobile cigar lighter plug, wherein the automobile cigar lighter plug may comprise a USD socket.

In a preferred embodiment of the present invention, the circuit module may further comprise a connection wire connecting to an electronic device.

In a preferred embodiment of the present invention, the button set may be a five-direction button.

In a preferred embodiment of the present invention, the button set may comprise a press button and a knob.

In a preferred embodiment of the present invention, the automobile push-button type control device may further comprise a button set, and the button set is disposed on the side of the casing and electrically connected to the circuit module.

To achieve the foregoing objective, the second embodiment of the present invention further provides an automobile push-button type control device. The device comprises a casing, a circuit module, a button set and an automobile cigar lighter plug.

In a preferred embodiment of the present invention, the circuit module may further comprise a connection wire connecting to an electronic device.

In a preferred embodiment of the present invention, the button set may be a five-direction button.

In a preferred embodiment of the present invention, the button set may comprise a press button and a knob.

In a preferred embodiment of the present invention, the automobile push-button type control device may further comprise a button set, and the button set is disposed on the side of the casing and electrically connected to the circuit module.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic view of the first embodiment of an automobile push-button type control device in accordance with the present invention.

FIG. 2 is a cross-sectional view of the first embodiment in accordance with the present invention after the device is connected to an electronic device.

FIG. 3 is a schematic view of an automobile cigar lighter plug in accordance with the present invention.

FIG. 4 is a schematic view of the second embodiment of an automobile push-button type control device in accordance with the present invention.

FIG. 5 is a cross-sectional view of the second embodiment in accordance with the present invention after the device is connected to an electronic device.

### DETAILED DESCRIPTION OF THE PREFERRED EMBODIMENTS

The technical content of the present invention will become apparent by the detailed description of the following embodiments and the illustration of related drawings as follows.

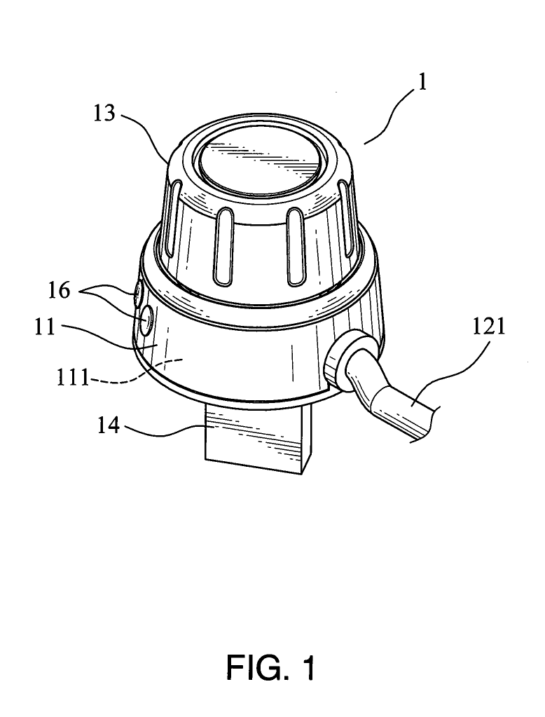

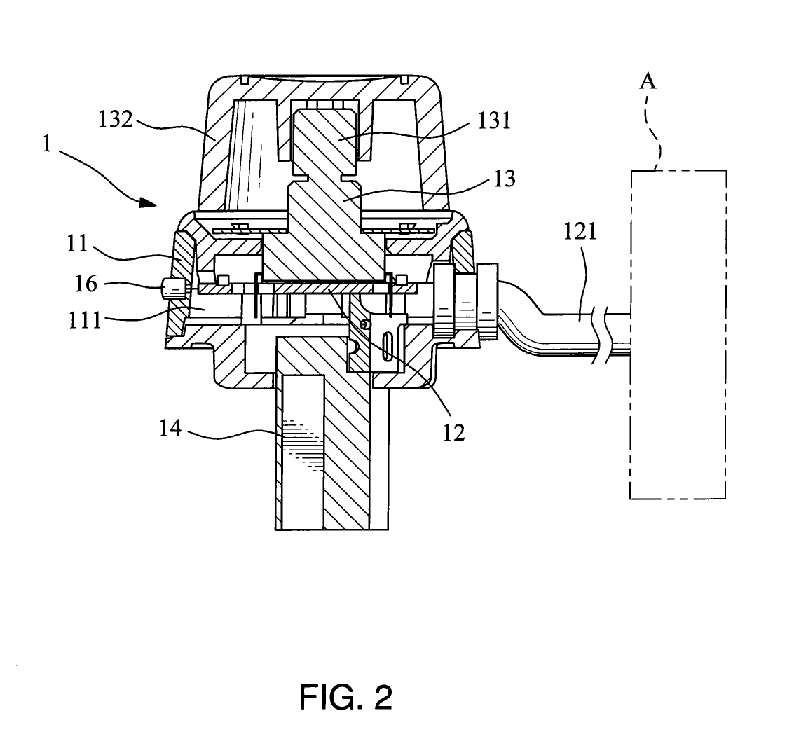

With reference to FIG. 1 and FIG. 2 for the first embodiment of an automobile push-button type control device 1 in accordance with the present invention, the automobile push-button type control device 1 comprises a casing 11, a circuit module 12, a button set 13 and a USB plug 14. The casing 11 has an accommodating space 111. The circuit module 12 is disposed in the accommodating space 111. The button set 13 is disposed above the circuit module 12 and electrically connected to the circuit module 12. The USB plug 14 is disposed below the circuit module 12 and electrically connected to the circuit module 12. The circuit module 12 further comprises a connection wire 121 connecting to an electronic device A. The electronic device A may be a navigation device, head up display or event data recorder, and the electronic device A can be controlled via the button set 13.

With reference to FIG. 2 for a cross-sectional view of the present invention, the button set 13 comprises a press button 131 and a knob 132. The functions of the button set 13 can vary with the electronic device A;

therefore, the press button 131 may be a play button or an answer button, and the knob 132 may be a volume control button. For example, the knob 132 may be rotated right to increase the volume, or the knob 132 may be rotated left to decrease the volume.

The knob 132 can also be a radio frequency adjustment button. For example, the knob 132 may be rotated right to increase the frequency, or the knob 132 may be rotated left to decrease the frequency.

The button set 13 is a five-direction button (the five-direction button should be known by those skilled in the art; therefore, it is not shown in the drawings. The five-direction button comprises four direction buttons and a press button. The direction buttons are up button, down button, left button and right button). The five-direction button can be used to control a cursor, where the up button, down button, left button and right button can be used to move the cursor up, down, left and right respectively, and the press button is a confirmation button.

The button set 13 is a five-direction button. Pressing the direction buttons of the five-direction button can perform various functions. Take the operation of a radio station as an example, pressing the left button is to search the previous station (the adjacent station with lower frequency); pressing the right button is to search the next station. Pressing the up button is to fine-tune the frequency upward for one level (take FM as an example, pressing the up button is to increase the frequency by 0.1 or 0.05 MHz); pressing the down button is to fine-tune the frequency downward for one level (take FM as an example, pressing the down button is to decrease the frequency by 0.1 or 0.05 MHz).

The automobile push-button type control device 1 in accordance with the prevent invention may further comprise a button set 16, and the button set 16 is disposed on the side of the casing 11 and electrically connected to the circuit module 12. The button set 16 is composed of one or several buttons to perform rapidly switching operation. For example, the button set 16 can be used to turn on or turn off the night vision system or switch screens.

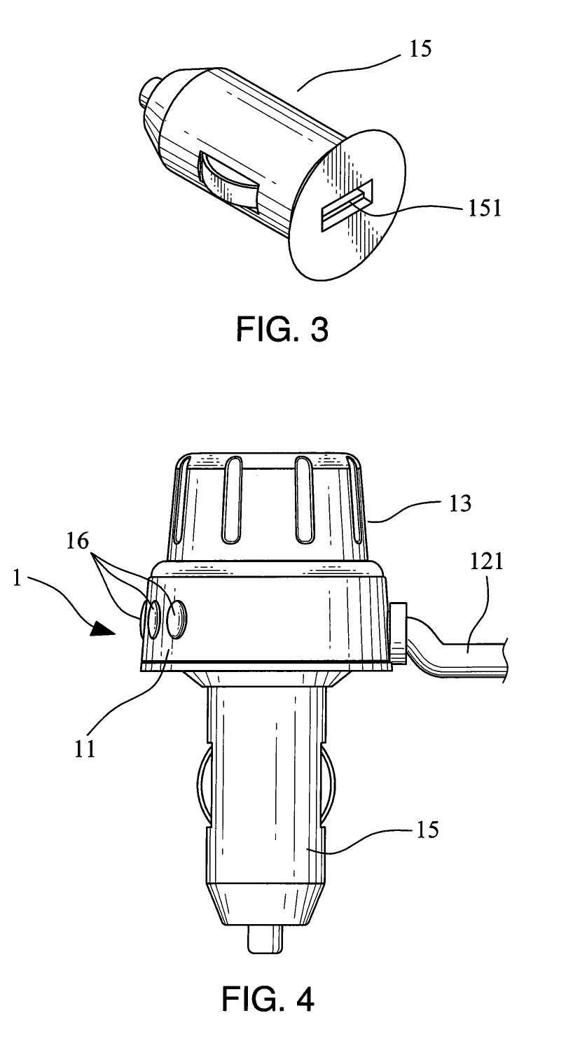

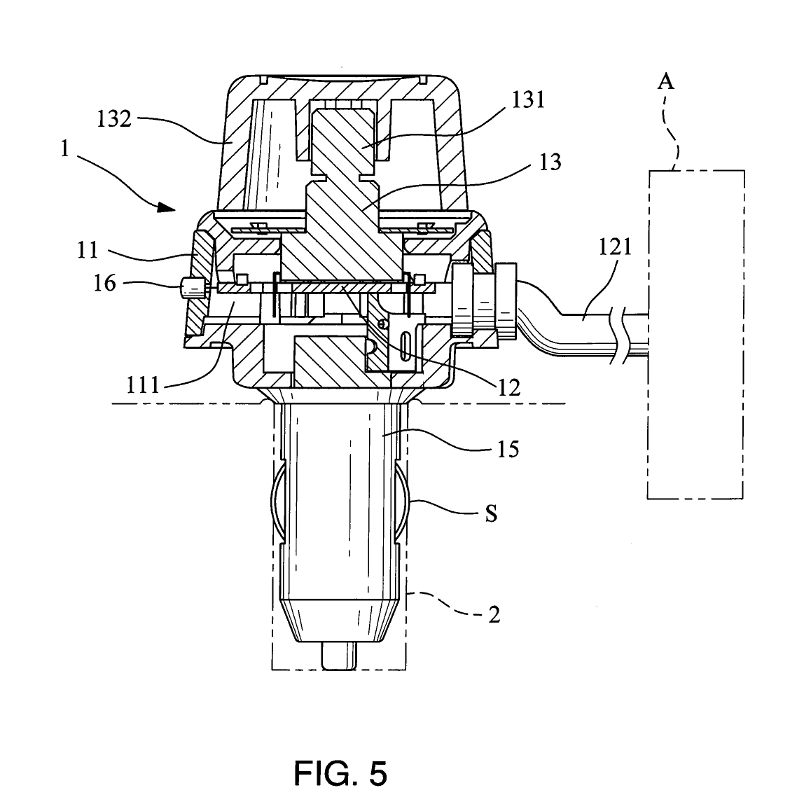

With reference to FIG. 3 for a schematic view of an automobile cigar lighter plug in accordance with the present invention, the first embodiment of the automobile push-button type control device 1 in accordance with the present invention can further comprise an automobile cigar lighter plug 15. The automobile cigar lighter plug 15 comprises a USD socket 151 for the USB plug 14 to be inserted into. The automobile cigar lighter plug 15 can be inserted into a cigar lighter socket 2 of a car (as shown in FIG. 5) to obtain electricity from the car as the power supply of the automobile push-button type control device 1. Besides, as the lateral elastic plates S lean against the internal surface of the cigar lighter socket 2; hence, the automobile cigar lighter plug 15 can be completely fixed and will not drop off from the cigar lighter socket 2.

With reference to FIG. 4 and FIG. 5 for the second embodiment of an automobile push-button type control device 1 in accordance with the present invention, the automobile push-button type control device 1 comprises a casing 11, a circuit module 12, a button set 13 and an automobile cigar lighter plug 15. The casing 11 has an accommodating space 111. The circuit module 12 is disposed in the accommodating space 111. The button set 13 is disposed above the circuit module 12 and electrically connected to the circuit module 12. The automobile cigar lighter plug 15 is disposed below the circuit module 12 and electrically connected to the circuit module 12. The automobile cigar lighter plug 15 can be inserted into a cigar lighter socket 2 of a car to obtain electricity from the car as the power supply of the automobile push-button type control device 1. The electronic device A may be a navigation device, head up display or event data recorder, and the electronic device A can be controlled via the button set 13.

With reference to FIG. 5 for a cross-sectional view of the present invention, the button set 13 comprises a press button 131 and a knob 132. The functions of the button set 13 can vary with the electronic device A; therefore, the press button 131 may be a play button or an answer button, and the knob 132 may be a volume control button. For example, the knob 132 may be rotated right to increase the volume, or the knob 132 may be rotated left to decrease the volume.

The knob 132 can also be a radio frequency adjustment button. For example, the knob 132 may be rotated right to increase the frequency, or the knob 132 may be rotated left to decrease the frequency.

The button set 13 is a five-direction button (the five-direction button should be known by those skilled in the art; therefore, it is not shown in the drawings. The five-direction button comprises four direction buttons and a press button. The direction buttons are up button, down button, left button and right button). The five-direction button can be used to control a cursor, where the up button, down button, left button and right button can be used to move the cursor up, down, left and right respectively, and the press button is a confirmation button.

The button set 13 is a five-direction button. Pressing the direction buttons of the five-direction button can perform various functions. Take the operation of a radio station as an example, pressing the left button is to search the previous station (the adjacent station with lower frequency); pressing the right button is to search the next station. Pressing the up button is to fine-tune the frequency upward for one level (take FM as an example, pressing the up button is to increase the frequency by 0.1 or 0.05 MHz); pressing the down button is to fine-tune the frequency downward for one level (take FM as an example, pressing the down button is to decrease the frequency by 0.1 or 0.05 MHz).

The automobile push-button type control device 1 in accordance with the prevent invention may further comprise a button set 16, and the button set 16 is disposed on the side of the casing 11 and electrically connected to the circuit module 12. The button set 16 is composed of one or several buttons to perform rapidly switching operation. For example, the button set 16 can be used to turn on or turn off the night vision system or switch screens.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An automobile push-button type control device, comprising:
a casing, having an accommodating space;
a circuit module, disposed in the accommodating space;
a button set, disposed above the circuit module and electrically connected to the circuit module; and
a USB plug, disposed below the circuit module and electrically connected to the circuit module.

2. The automobile push-button type control device of claim 1, further comprising an automobile cigar lighter plug, wherein the automobile cigar lighter plug comprises a USD socket.

3. The automobile push-button type control device of claim 1, wherein the circuit module further comprises a connection wire connecting to an electronic device.

4. The automobile push-button type control device of claim 1, wherein the button set is a five-direction button.

5. The automobile push-button type control device of claim 1, wherein the button set comprises a press button and a knob.

6. The automobile push-button type control device of claim 1, further comprising a button set, wherein the button is disposed on a side of the casing and electrically connected to the circuit module.

7. An automobile push-button type control device, comprising:
a casing, having an accommodating space;
a circuit module, disposed in the accommodating space;
a button set, disposed above the circuit module and electrically connected to the circuit module; and
an automobile cigar lighter plug, disposed below the circuit module and electrically connected to the circuit module.

8. The automobile push-button type control device of claim 7, wherein the button set is a five-direction button.

9. The automobile push-button type control device of claim 7, wherein the button set comprises a press button and a knob.

10. The automobile push-button type control device of claim 7, wherein the circuit module further comprises a connection wire connecting to an electronic device.

11. The automobile push-button type control device of claim 7, further comprising a button set, wherein the button is disposed on a side of the casing and electrically connected to the circuit module.
